(19) United States
(12) Patent Application Publication
(10) Pub. No.: US 2026/0038353 A1
(43) Pub. Date: Feb. 5, 2026

(54) SMOKE DETECTOR LIGHT SOURCE AND SENSOR TO EMIT AND DETECT POLARIZED LIGHT

(71) Applicant: Microchip Technology Incorporated, Chandler, AZ (US)

(72) Inventors: Patrick McFarland, Gilbert, AZ (US); Arthur B. Eck, Gilbert, AZ (US); Jonathan Corbett, Havertown, PA (US)

(73) Assignee: Microchip Technology Incorporated, Chandler, AZ (US)

(21) Appl. No.: 18/908,932

(22) Filed: Oct. 8, 2024

Related U.S. Application Data
(60) Provisional application No. 63/677,962, filed on Jul. 31, 2024.

(51) Int. Cl. G08B 17/107; G01N 21/21; G01N 21/47; G01N 21/53

(52) U.S. Cl. CPC G08B 17/107; G01N 21/21; G01N 21/532; G01N 2021/4707; G01N 2021/4792

(57) ABSTRACT

A system and method for a photoelectric smoke detector using polarized light is disclosed. The system may include a light source to emit a beam of light at a polarity of interest. The system may also include a light sensor to detect a reflection of the beam of light at the polarity of interest. The system may additionally include a control circuit communicatively coupled to the light sensor. The control circuit may be to detect a presence of smoke and raise a smoke alarm signal. The polarity of interest may be based on an angle of incidence between the light source and the light sensor.

### PRIORITY

This application claims priority to U.S. Provisional Patent Application No. 63/677,962 filed Jul. 31, 2024, the contents of which are hereby incorporated in their entirety.

### TECHNICAL FIELD

The present disclosure relates to photoelectric smoke detectors and, in particular, to a smoke detector light source and sensor to emit and detect polarized light.

### BACKGROUND

A photoelectric smoke detector uses non-polarized light to detect smoke particles. A light source in the smoke detector emits a small light beam within a chamber of the detector. When smoke particles enter the chamber, the smoke particles scatter the light beam. A light sensor in the smoke detector detects the scattered light to allow an alarm to be triggered. The light source and light sensor may be positioned off angle such that when smoke enters the chamber, the smoke reflects the light and causes the receiver to receive the reflected light.

Underwriters Laboratories (UL) establishes standards for product safety. UL standards for smoke detectors establish, for example, sensitivity and reliability standards. UL standards that smoke detectors have less sensitivity to cooking fires and more sensitivity to smoldering fires. These standards have resulted in the tripping point of a smoke detector moving closer to the noise floor, causing light leakage into the chamber to be a greater problem.

### SUMMARY OF THE INVENTION

Aspects provide systems and methods for a photoelectric smoke detector including a light source and sensor to emit and detect polarized light. Examples of the present disclosure may include an apparatus. The apparatus may include a light source in a smoke detector to emit a beam of light at a polarity of interest. The apparatus may also include a light sensor to detect a reflection of the beam of light at the polarity of interest. The reflection may be created when the beam of light reflects off a smoke particle. The polarity of interest may be based on an angle of incidence between the light source and the light sensor.

In combination with any of the above examples, the light source may include at least one of a wave plate, a light pipe, or a filter to polarize the beam of light to the polarity of interest.

In combination with any of the above examples, the light source may generate light at the polarity of interest.

In combination with any of the above examples, the light source may be a vertical cavity surface emitting laser.

In combination with any of the above examples, the light sensor may include a filter to block light having a polarity different from the polarity of interest.

In combination with any of the above examples, the apparatus may further include a smoke detection chamber and a plurality of baffles along a perimeter of the smoke detection chamber.

In combination with any of the above examples, the light source may emit the beam of light with a polarity at an angle orthogonal to the polarity of the light reflected through the plurality of baffles.

Alone or in combination with any of the above examples, examples of the present disclosure may include a method. The method may include instructing a light source to emit a beam of light at a polarity of interest, the polarity of interest based on an angle of incidence between the light source and a light sensor. The method may also include receiving a signal indicative of a reflection of the beam of light at the polarity of interest. The method may additionally include analyzing the signal to determine whether to raise a smoke alarm signal.

In combination with any of the above examples, instructing the light source to emit the beam of light at a polarity of interest includes using at least one of a wave plate, a light pipe, or a filter to polarize the beam of light to the polarity of interest.

In combination with any of the above examples, instructing the light source to emit the beam of light at a polarity of interest includes generating light at the polarity of interest.

In combination with any of the above examples, instructing the light source to emit the beam of light at a polarity of interest includes using a vertical cavity surface emitting laser to polarize the beam of light to the polarity of interest.

In combination with any of the above examples, receiving the signal indicative of the reflection of the beam of light at the polarity of interest includes using a filter at the light sensor to block light having a polarity different from the polarity of interest.

In combination with any of the above examples, instructing the light source to emit the beam of light at a polarity of interest includes instructing the light source to emit the beam of light at an angle orthogonal to the polarity of the light reflected through a plurality of baffles arranged along a perimeter of a smoke detection chamber.

Alone or in combination with any of the above examples, examples of the present disclosure may include a system. The system may include a light source to emit a beam of light at a polarity of interest. The system may also include a light sensor to detect a reflection of the beam of light at the polarity of interest. The system may additionally include a control circuit communicatively coupled to the light sensor. The control circuit may be to detect a presence of smoke and raise a smoke alarm signal. The polarity of interest may be based on an angle of incidence between the light source and the light sensor.

In combination with any of the above examples, the light source may include at least one of a wave plate, a light pipe, or a filter to polarize the beam of light to the polarity of interest.

In combination with any of the above examples, the light source may generate light at the polarity of interest.

In combination with any of the above examples, the light source may be a vertical cavity surface emitting laser.

In combination with any of the above examples, the light sensor may include a filter to block light having a polarity different from the polarity of interest.

In combination with any of the above examples, the system may include a smoke detection chamber and a plurality of baffles along a perimeter of the smoke detection chamber.

In combination with any of the above examples, the light source may be to emit the beam of light with a polarity at an angle orthogonal to the polarity of the light reflected through the plurality of baffles.

### BRIEF DESCRIPTION OF THE DRAWINGS

The figures illustrate examples of systems and methods for a photoelectric smoke detector including a light source and sensor to emit and detect polarized light.

FIG. 1 illustrates a side view of a photoelectric smoke detector including a light source and sensor to emit and detect polarized light, according to examples of the present disclosure;

FIGS. 2A and 2B illustrate side and top views of a photoelectric smoke detector, respectively, including a light source and sensor to emit and detect polarized light, according to examples of the present disclosure;

FIG. 3 illustrates a top view of a photoelectric smoke detector including a light source and sensor to emit and detect polarized light, according to examples of the present disclosure;

FIG. 4 illustrates a block diagram of a photoelectric smoke detector including a light source and sensor to emit and detect polarized light, according to examples of the present disclosure;

FIG. 5 illustrates a method of operating a photoelectric smoke detector including a light source and sensor to emit and detect polarized light, according to examples of the present disclosure; and

FIG. 6 illustrates a more detailed method of operating a photoelectric smoke detector including a light source and sensor to emit and detect polarized light, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a photoelectric smoke detector including a light source and sensor to emit and detect polarized light is provided. The photoelectric smoke detector may use polarized transmitted light, polarized received light, or both to improve the performance of the photoelectric smoke detector. For example, the use of polarized light may result in one or more of the following benefits: reduced noise, reduced energy usage, increased battery life, reduced the cost of the light source in the smoke detector, and reduced the cost of the power supply of the smoke detector. The reduction of noise (e.g., interfering light) in the smoke detector may increase compliance with more stringent certification specifications by providing a greater ability to differentiate between interfering light and smoke particles. Additionally, the smoke detector may consume less energy.

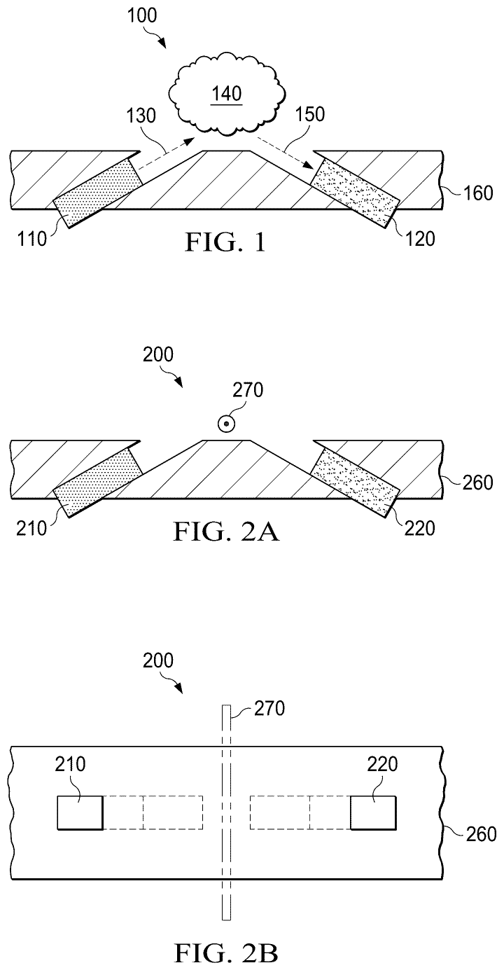

FIG. 1 illustrates a side view of a photoelectric smoke detector including a light source and sensor to emit and detect polarized light, according to examples of the present disclosure. Photoelectric smoke detector 100 may include light source 110 and light sensor 120.

Light source 110 may emit light beam 130. Light source 110 may be any suitable type of light source, such as, but not limited to, a light emitting diode (LED), a vertical cavity surface emitting laser, or an incandescent light bulb. Light beam 130 may be formed of infrared, visible, or ultraviolet light. When smoke is present, light beam 130 may reflect off smoke particles 140, resulting in reflected light beam 150. Reflected light beam 150 may be received by light sensor 120. Light sensor 120 may be any suitable type of light sensor, such as, but not limited to, a photodiode or a phototransistor. In some examples, light sensor 120 may include multiple light sensors. When reflected light beam 150 is received by light sensor 120, light sensor 120 may generate an electrical signal that may be analyzed to determine when to sound a fire alarm.

Light source 110 and light sensor 120 may be mounted in carrier 160. Carrier 160 may provide connections between light source 110, light sensor 120, and other circuits in photoelectric smoke detector 100, such as, but not limited to, a control circuit, alarm circuit, and power supply. Light source 110 and light sensor 120 may be spaced apart from each other such that light sensor 120 does not receive light beam 130 directly.

When light beam 130 is reflected off smoke particles 140, reflected light beam 150 is polarized. To reduce the noise in the signal from light sensor 120 caused by extraneous light (e.g., light not corresponding to light beam 130), instead of emitting a non-polarized light beam, light source 110 may emit light beam 130 as a polarized light beam. As illustrated in more detail with respect to FIGS. 2A and 2B, light source 110 may emit light beam 130 at a polarization corresponding to the angle of incidence of reflected light beam 150 after light beam 130 is reflected off smoke particles 140 (“the polarity of interest”). Light source 110 may include an optical device to polarize light beam 130. The optical device may include, but not limited to, a wave plate, a polarizing filter, or a light pipe. In some examples, light source 110 may generate polarized light without the use of an additional device. For example, light source 110 may include LEDs that generate polarized light.

Light sensor 120 may detect reflected light beam 150 at a polarization corresponding to the polarization of reflected light beam 150. By receiving light at the polarity of interest and not at other polarities, light sensor 120 may not detect extraneous light that does not have the same polarization. Light sensor 120 may include an optical device to filter out light that is not at the polarity of interest, such as, but not limited to, a polarity light filter, a linear polarizing filter, a polarized lens, or an interference filter.

Light sensor 120 detecting light at the polarity of interest may reduce the noise in the signal from light sensor 120 caused by extraneous light, increasing the signal to noise ratio of the signal from light sensor 120. The increase in the signal to noise ratio of the signal from light sensor 120 may allow light source 110 to emit light beam 130 at a lower brightness which may reduce the energy usage of photoelectric smoke detector 100. Reduced energy usage of photoelectric smoke detector 100 may reduce the costs associated with delivering power to the components of photoelectric smoke detector 100 (e.g., batteries, power supply, and loop wire included in photoelectric smoke detector 100) because light source 110 may not use energy generating light beam 130 at unwanted polarities.

In some examples, photoelectric smoke detector 100 may use polarized light to reduce the noise in the signal from light sensor 120 by including polarity filters at light source 110 or light sensor 120, but not both. For example, light source 110 may include an optical device to polarize light beam 130. The optical device may include, but not limited to, a wave plate, a polarizing filter, or a light pipe. Alternatively, light source 110 may generate polarized light without the use of an additional device. For example, light source 110 may include LEDs that generate polarized light. In this example, light sensor 120 may be a conventional light sensor that detects light at all polarities and light sensor 120 may have a reduced cost when designed to detect light at all polarities. The signal from light sensor 120 may be analyzed to remove signals corresponding to light at polarities not at the polarity corresponding to the polarity of light beam 130. As another example, light source 110 may emit light beam 130 unpolarized and light sensor 120 may include an optical device to filter out light that is not at the polarity of interest, such as, but not limited to, a polarity light filter, a linear polarizing filter, a polarized lens, or an interference filter. In this example, while light beam 130 is emitted unpolarized, because light sensor 120 detects reflected light beam 150 at the polarity of interest, light at other polarities is filtered out of the signal from light sensor 120, reducing the noise in the signal.

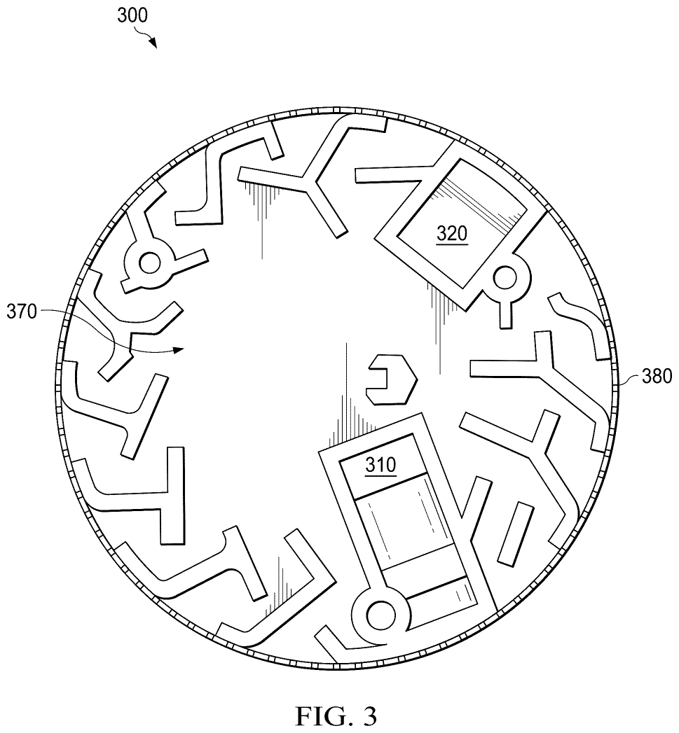

Photoelectric smoke detector 100 may be used in an open room (e.g., chamberless) where the extraneous light may not result in noise in the signal from light sensor 120 because the extraneous light in the room is mostly not polarized at the polarity of interest. Alternatively, photoelectric smoke detector 100 may include a chamber in which light source 110 and light sensor 120 are housed, as described in more detail with respect to FIG. 3.

FIGS. 2A and 2B illustrate side and top views of a photoelectric smoke detector, respectively, including a light source and sensor to emit and detect polarized light, according to examples of the present disclosure. Light source 210, light sensor 220, and carrier 260 may be similar to light source 110, light sensor 120, and carrier 160, respectively, shown in FIG. 1. When light source 210 emits a light beam, such as light beam 130, the reflected light beam, such as reflected light beam 150, is reflected about axis of reflection 270 and has a polarity parallel to carrier 260. In contrast, extraneous light may have a polarity orthogonal to carrier 260.

FIG. 3 illustrates a top view of a photoelectric smoke detector including a light source and sensor to emit and detect polarized light, according to examples of the present disclosure. Photoelectric smoke detector 300 may include light source 310 and light sensor 320 housed in smoke detection chamber 370 surrounded by baffles 380.

Light source 310 may be similar to light source 110 shown in FIG. 1 and light sensor 320 may be similar to light sensor 120 shown in FIG. 1. Light source 310 and light sensor 320 may be used to detect the presence of smoke particles within smoke detection chamber 370.

Baffles 380 may be arranged along the outer perimeter of smoke detection chamber 370. Baffles 380 may allow smoke to enter smoke detection chamber 370 and may reduce the amount of extraneous light entering smoke detection chamber 370. If extraneous light enters the chamber, the extraneous light may be detected by light sensor 320, causing the smoke detector to incorrectly identify the presence of smoke particles. Extraneous light entering smoke detection chamber 370 (referred to as “baffle reflection leakage light”) may be light reflected off baffles 380. The baffle reflection leakage light has a polarity of the angle of incidence of the reflected light.

The polarity of the baffle reflection leakage light may be different from the polarity of the light beam emitted by light source 310 and detected by light sensor 320. Therefore, because light sensor 320 detects light at a different polarity than the baffle reflection leakage light, light sensor 320 may not detect the baffle reflection leakage light and no noise from the baffle reflection leakage light is introduced in the signal from light sensor 320. As such, the signal to noise ratio of the signal from light sensor 320 may be increased.

Light source 310 and light sensor 320 may be arranged such that the angle of incidence of the reflected light beam after the light beam emitted from light source 310 reflects off smoke particles in smoke detection chamber 370 is orthogonal to the baffle reflection leakage light. For example, like light source 110 and light sensor 120 shown in FIG. 1, light source 310 and light sensor 320 may be angled at approximately 20 to 30 degrees relative to the floor (e.g., carrier 160 shown in FIG. 1) of smoke detection chamber 370. Arranging light source 310 and light sensor 320 such that the reflected light beam is orthogonal to the baffle reflection leakage light may further reduce the noise in the signal from light sensor 320. In this example, the light beam emitted by light source 310 may have a polarity parallel to the floor of smoke detection chamber 370. Alternatively, light source 310 and light sensor 320 may be arranged parallel to the floor of smoke detection chamber 370.

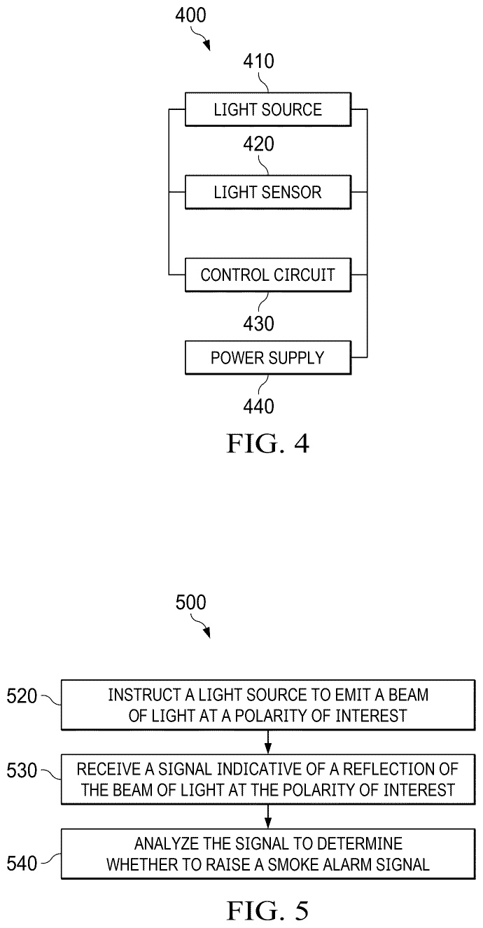

FIG. 4 illustrates a block diagram of a photoelectric smoke detector including a light source and sensor to emit and detect polarized light, according to examples of the present disclosure. Photoelectric smoke detector 100 may include light source 410, light sensor 420, control circuit 430, and power supply 440.

Light source 410 may be similar to light source 110, light source 210, or light source 310 described with respect to FIGS. 1, 2, and 3, respectively. Light source 410 may emit a light beam based on a command from control circuit 430. Light source 410 may be any suitable type of light source, such as, but not limited to, a light emitting diode (LED), a vertical cavity surface emitting laser, or an incandescent light bulb.

Light sensor 420 may be similar to light sensor 120, light sensor 220, or light sensor 320 described with respect to FIGS. 1, 2, and 3, respectively. Light sensor 420 may be any suitable type of light sensor, such as, but not limited to, a photodiode or a phototransistor. In some examples, light sensor 420 may include multiple light sensors. When a reflected light beam is received by light sensor 420, light sensor 420 may generate an electrical signal that may be transmitted to control circuit 430 for processing and analysis to determine when to sound a fire alarm.

Control circuit 430 may receive the electrical signal from light sensor 420 and process and analyze the signal. Control circuit 430 may, when the electrical signal from light sensor 420 exceeds a threshold, sound an alarm indicating the presence of smoke in the vicinity of photoelectric smoke detector 400. Control circuit 430 may also analyze the electrical signal from light sensor 420 to remove signals corresponding to light at polarities not at the polarity corresponding to the polarity of the light beam emitted by light source 410. Control circuit 430 may include a central processing unit (CPU), a general purpose processor, a specific purpose processor, a microcontroller, a programmable logic controller (PLC), a digital signal processor (DSP), an analog front-end (AFE), an application specific integrated circuit (ASIC), a field-programmable gate array (FPGA) or other programmable logic device, discrete gate or transistor logic, discrete hardware components, other programmable device, or any combination thereof.

Power supply 440 may power the components of photoelectric smoke detector 400 including light source 410, light sensor 420, and control circuit 430. Because light sensor 420 may detect light at a polarity of interest (as described with respect to FIG. 1) the noise in the signal from light sensor 420 caused by extraneous light may be reduced, increasing the signal to noise ratio of the signal from light sensor 420. The increase in the signal to noise ratio of the signal from light sensor 420 may allow light source 410 to emit a light beam at a lower brightness which may reduce the energy usage of photoelectric smoke detector 400. Therefore, the size of power supply 440 may be reduced.

FIG. 5 illustrates a method of operating a photoelectric smoke detector including a light source and sensor to emit and detect polarized light, such as photoelectric smoke detector 100, 200, 300, or 400 shown in FIGS. 1, 2, 3, and 4, respectively, according to examples of the present disclosure. Method 500 may be implemented using may be implemented using a control circuit, such as control circuit 430 shown in FIG. 4. The control circuit may include a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 500. Although examples have been described above, other variations and examples may be made from this disclosure without departing from the spirit and scope of these disclosed examples.

Method 500 may begin at block 520 where the control circuit may instruct a light source to emit a beam of light at a polarity of interest. The polarity of interest may be based on an angle of incidence between a light source emitting a beam of light and a light sensor detecting a reflection of the beam of light. For example, the light source may emit a light beam at a polarization corresponding to the angle of incidence of a reflected light beam after the light beam is reflected off a smoke particle. The light source may be constructed such that the beam of light emitted by the light source is polarized at the polarity of interest. For example, the light source may include an optical device to polarize the light beam. The optical device may include, but not limited to, a wave plate, a polarizing filter, or a light pipe. In some examples, the light source may generate polarized light without the use of an additional device. For example, the light source may include LEDs that generate polarized light. When the control circuit instructs the light source to emit the beam of light, the light source is activated and the beam emitted by the light source is at the polarity of interest.

At block 530, the control circuit may receive a signal indicative of a reflection of the beam of light at the polarity of interest. The light sensor may detect the reflected light beam at a polarization corresponding to the polarization of the reflected light beam. The light sensor may include an optical device to block light that is not at the polarity of interest, such as, but not limited to, a polarity light filter, a linear polarizing filter, a polarized lens, or an interference filter. The light sensor may transmit a signal to the control circuit indicative of the reflected light beam.

At block 540, the control circuit may analyze the signal to determine whether to raise a smoke alarm signal. For example, the control circuit may, when the electrical signal from the light sensor exceeds a threshold, sound an alarm indicating the presence of smoke in the vicinity of the photoelectric smoke detector.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

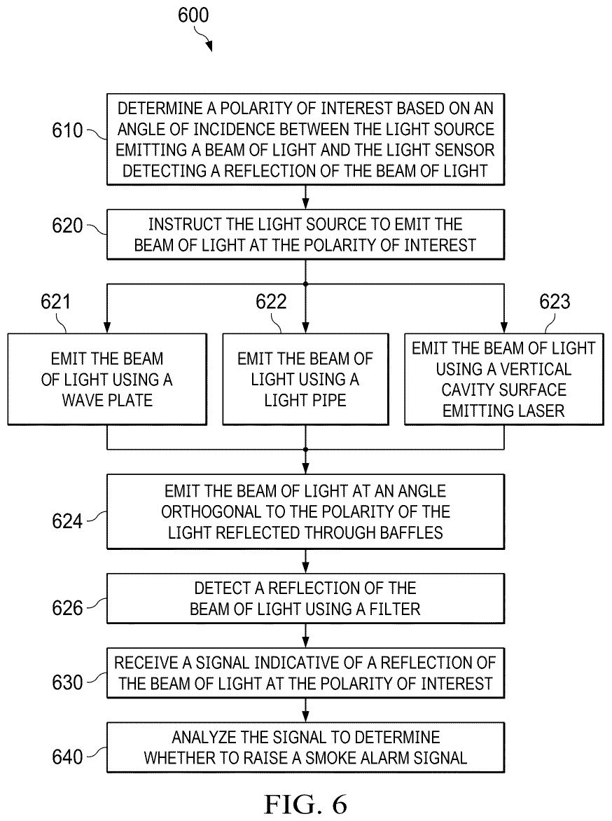

FIG. 6 illustrates a more detailed method of operating a photoelectric smoke detector including a light source and sensor to emit and detect polarized light, such as photoelectric smoke detector 100, 200, 300, or 400 shown in FIGS. 1, 2, 3, and 4, respectively, according to examples of the present disclosure. Method 600 may be implemented using may be implemented using a control circuit, such as control circuit 430 shown in FIG. 4. The control circuit may include a central processing unit (CPU), a general purpose processor, a specific purpose processor, a microcontroller, a programmable logic controller (PLC), a digital signal processor (DSP), an analog front-end (AFE), an application specific integrated circuit (ASIC), a field-programmable gate array (FPGA) or other programmable logic device, discrete gate or transistor logic, discrete hardware components, other programmable device, or any combination thereof designed to implement method 600. Although examples have been described above, other variations and examples may be made from this disclosure without departing from the spirit and scope of these disclosed examples.

Method 600 may begin at block 610 where the control circuit may determine a polarity of interest. The polarity of interest may be based on an angle of incidence between a light source emitting a beam of light and a light sensor detecting a reflection of the beam of light. For example, the light source may emit a light beam at a polarization corresponding to the angle of incidence of a reflected light beam after the light beam is reflected off a smoke particle.

At block 620, the control circuit may instruct the light source to emit the beam of light at the polarity of interest. The light source may be constructed such that the beam of light emitted by the light source is polarized at the polarity of interest. For example, the light source may include an optical device to polarize the light beam. The optical device may include, but not limited to, a wave plate, a polarizing filter, or a light pipe. In some examples, the light source may generate polarized light without the use of an additional device. For example, the light source may include LEDs that generate polarized light. When the control circuit instructs the light source to emit the beam of light, the light source is activated and the beam emitted by the light source is at the polarity of interest.

At block 621, the light source may emit the beam of light using a wave plate to polarize the beam of light.

At block 622, the light source may emit the beam of light using a light pipe to polarize the beam of light.

At block 623, the light source may emit the beam of light using a vertical cavity surface emitting laser to polarize the beam of light.

At block 624, the light source may emit the beam of light at an angle orthogonal to the polarity of the light reflected through baffles of the photoelectric smoke detector (e.g., the baffle reflection leakage light).

At block 626, the light sensor may detect a reflection of the beam of light at a polarity corresponding to the polarity of interest by using a filter to filter out light at other polarities.

At block 630, the control circuit may receive a signal indicative of a reflection of the beam of light at the polarity of interest. The light sensor may detect the reflected light beam at a polarization corresponding to the polarization of the reflected light beam. The light sensor may include an optical device to filter out light that is not at the polarity of interest, such as, but not limited to, a polarity light filter, a linear polarizing filter, a polarized lens, or an interference filter. The light sensor may transmit a signal to the control circuit indicative of the reflected light beam.

At block 640, the control circuit may analyze the signal to determine whether to raise a smoke alarm signal. For example, the control circuit may, when the electrical signal from the light sensor exceeds a threshold, sound an alarm indicating the presence of smoke in the vicinity of the photoelectric smoke detector.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. An apparatus, comprising:
a light source in a smoke detector to emit a beam of light at a polarity of interest; and
a light sensor to detect a reflection of the beam of light at the polarity of interest, the reflection created when the beam of light reflects off a smoke particle;
wherein the polarity of interest based on an angle of incidence between the light source and the light sensor.

2. The apparatus of claim 1, wherein the light source includes at least one of a wave plate, a light pipe, or a filter to polarize the beam of light to the polarity of interest.

3. The apparatus of claim 1, wherein the light source generates light at the polarity of interest.

4. The apparatus of claim 1, wherein the light source is a vertical cavity surface emitting laser.

5. The apparatus of claim 1, wherein the light sensor includes a filter to block light having a polarity different from the polarity of interest.

6. The apparatus of claim 1, further comprising:
a smoke detection chamber; and
a plurality of baffles along a perimeter of the smoke detection chamber.

7. The apparatus of claim 6, wherein the light source is to emit the beam of light with a polarity at an angle orthogonal to the polarity of the light reflected through the plurality of baffles.

8. A method, comprising:
instructing a light source to emit a beam of light at a polarity of interest, the polarity of interest based on an angle of incidence between the light source and a light sensor;
receiving a signal indicative of a reflection of the beam of light at the polarity of interest; and
analyzing the signal to determine whether to raise a smoke alarm signal.

9. The method of claim 8, wherein instructing the light source to emit the beam of light at a polarity of interest includes using at least one of a wave plate, a light pipe, or a filter to polarize the beam of light to the polarity of interest.

10. The method of claim 8, wherein instructing the light source to emit the beam of light at a polarity of interest includes generating light at the polarity of interest.

11. The method of claim 8, wherein instructing the light source to emit the beam of light at a polarity of interest includes using a vertical cavity surface emitting laser to polarize the beam of light to the polarity of interest.

12. The method of claim 8, wherein receiving the signal indicative of the reflection of the beam of light at the polarity of interest includes using a filter at the light sensor to block light having a polarity different from the polarity of interest.

13. The method of claim 8, wherein instructing the light source to emit the beam of light at a polarity of interest includes instructing the light source to emit the beam of light at an angle orthogonal to the polarity of the light reflected through a plurality of baffles arranged along a perimeter of a smoke detection chamber.

14. A system, comprising:
a light source to emit a beam of light at a polarity of interest;
a light sensor to detect a reflection of the beam of light at the polarity of interest; and
a control circuit communicatively coupled to the light sensor, the control circuit to:
detect a presence of smoke; and
raise a smoke alarm signal;
wherein the polarity of interest based on an angle of incidence between the light source and the light sensor.

15. The system of claim 14, wherein the light source includes at least one of a wave plate, a light pipe, or a filter to polarize the beam of light to the polarity of interest.

16. The system of claim 14, wherein the light source generates light at the polarity of interest.

17. The system of claim 14, wherein the light source is a vertical cavity surface emitting laser.

18. The system of claim 14, wherein the light sensor includes a filter to block light having a polarity different from the polarity of interest.

19. The system of claim 14, further comprising:
a smoke detection chamber; and
a plurality of baffles along a perimeter of the smoke detection chamber.

20. The system of claim 19, wherein the light source is to emit the beam of light with a polarity at an angle orthogonal to the polarity of the light reflected through the plurality of baffles.
